(19) United States
(12) Patent Application Publication
(10) Pub. No.: US 2003/0166361 A1
(43) Pub. Date: Sep. 4, 2003

(54) Connector

(76) Inventor: Rick Yang, Hsin Chuang City (TW)

Correspondence Address: RABIN & BERDO, P.C., Suite 500, 1101 14th Street, N.W., Washington, DC, 20005, US

(21) Appl. No.: 10/085,038

(22) Filed: Mar. 1, 2002

(51) Int. Cl. H01R 13/502

(52) U.S. Cl. 439/701

(57) ABSTRACT

A connector mainly includes a plastic body having a steel case put over a front end thereof, an insertion plate connected to a rear end of the plastic body, an intermediate cable including two rows of conductors separately set onto upper rear and lower rear sides of the insertion plate, and two hold-down plates separately covered onto upper and lower sides of the insertion plate to hold the conductors of the intermediate cable in place and then integrally connected to the insertion plate by way of high-frequency heat sealing. The plastic body, the insertion plate, and the hold-down plates are provided at predetermined positions with slots for receiving isolation plates therein, so that terminals inserted in the plastic body are individually surrounded by the isolation plates to eliminate mutual interference and therefore enable stable transmission of signals at high speed.

### BACKGROUND OF THE INVENTION

The present invention relates to a connector, and more particularly to a connector having individually isolated terminals to eliminate mutual interference between the terminals during high-speed signal transmission and therefore enable faster and more stable transmission of signals.

With the increasingly developed technologies, computers have been designed to provide incredibly powerful functions. That is, the central processing unit (CPU) inside each computer has higher operation ability than ever. Meanwhile, the Internet has become so popular that upload and download at extremely high speed via wide-band optical fiber, asymmetric digital subscriber line (ADSL) and the like has been developed in response to user demands. Thus, peripheral client/server configurations for using the Internet must have matched high operating speed. A cable for transmitting signals between the CPU of a computer and the client/server is therefore particularly important, and connectors at two ends of the cable are responsible for successful high-speed signal transmission.

FIGS. 1 and 2 are exploded and partially assembled perspective views, respectively, of a conventional connector. As shown, the conventional connector includes a plastic body 1, an insertion plate 2, two hold-down plates 3, a steel case 4 put onto a front end of the plastic body 1, and two intermediate cables 5.

Two rows of staggered terminals 11 are provided at upper and lower sides of the plastic body 1. The plastic body includes two rearward extended lateral walls 12, inner surfaces of which are provided with two guide ways 13 each having a retaining hole 14 provided therein, such that the insertion plate 2 can be connected to a rear side of the plastic body 1 by sliding it into the guide ways 13. Moreover, the two lateral walls 12 have two vertically extended insertion slots 15 symmetrically provided at their inner surfaces.

The insertion plate 2 is provided at two lateral sides with two retaining projections 22 for engaging with the retaining holes 14 in the guide ways 13 on the plastic body 1, so as to hold the insertion plate 2 to a rear side of the plastic body 1. The insertion plate 2 is also provided at upper and lower surfaces with a plurality of terminal slots 21 corresponding to the terminals 11. When the insertion plate 2 is connected to the rear side of the plastic body 1, rear ends of the terminals 11 are located in corresponding terminal slots 21 on the insertion plate 2. Rear ends of the terminal slots 21 are spaced from one another with spacing ribs 23. Middle portions of the spacing ribs 23 at both upper and lower sides of the insertion plate 2 are cut away to provide two transversely extended recesses 24. And, two vertically extended slots 25 are provided at two lateral sides of the insertion plate 2 corresponding to the insertion slots 15 on the plastic body 1.

Each of the hold-down plates 3 is provided at middle points of two lateral sides with two symmetric projections 31. The hold-down plates 3 are provided at a front part of one side facing the insertion plate 2 with a plurality of hold-down ribs 32 corresponding to and adapted to locate in the terminal slots 21. The projections 31 may be vertically guided into the insertion slots 15 to connect the hold-down plates 3 to the plastic body 1 and to separately locate at upper and lower sides of the insertion plate 2.

Each of the intermediate cables 5 includes a plurality of conductors 51 that are arranged in a predetermined manner corresponding to the terminals 11 on the plastic body 1, and a transverse clamp plate 53 holding the previously arranged conductors 51 in place. A fixed length of front ends of the conductors 51 are extended from a front side of the clamp plate 53 to expose a fixed length of bare wires 52.

To assemble the above-described conventional connector, first connect the insertion plate 2 to the rear side of the plastic body 1, and then set the clamp plates 53 of the cables 5 in the transverse recesses 24 at upper and lower sides of the insertion plate 2, as shown in FIG. 2, such that the conductors 51 are separately located in and between two adjacent spacing ribs 23 with the bare wires 52 pressed against rear ends of corresponding terminals 11. Thereafter, the two hold-down plates 3 are connected to the plastic body 1 to separately locate at upper and lower sides of the insertion plate 2 by guiding the projections 31 into the insertion slots 15 to engage with the slots 25. After the hold-down plates 3 are held in place, the hold-down ribs 32 provided at the front part of the hold-down plates 3 are separately located in corresponding terminal slots 21. Finally, rear parts of the hold-down plates 3 are integrally connected to tops of the spacing ribs 23, and the hold-down ribs 32 at the front parts of the hold-down plates 3 are integrally connected at two lateral sides to two lateral sides of corresponding terminal slots 21 by way of high-frequency heat sealing, as shown in FIG. 3. The steel case 4 is then put onto the front end of the plastic body 1 to complete the connector.

Please refer to FIG. 4 that is a sectional view taken along line A-A′ of FIG. 3. After the rear parts of the hold-down plates 3 are integrally connected to the tops of the spacing ribs 23 and the hold-down ribs 32 at the front parts of the hold-down plates 3 are integrally connected at two lateral sides to two lateral sides of corresponding terminal slots 21, the bare wires 52 are separately located in individual terminal slots 21 to tightly contact with rear ends of corresponding terminals 11, such that short circuit at joints of the bare wires 52 and the terminals 11 can be eliminated.

The following disadvantages are found in the above-described conventional connector:

1. When signals are transmitted at high speed via the closely arranged terminals, electric energy on the terminals produces radiation to result in mutual interfere of the terminals with one another and accordingly slow and unstable signal transmission.

2. During high-speed transmission, electric energy on the connector produces radiation to form noise or crosstalk that interferes with other terminals to result in worse signal transmission.

3. The terminals might have static electricity surrounded them due to some external factors that affect the connector. Such static electricity forms an interference source in signal transmission.

It is therefore desirable to develop an improved connector having individually isolated terminals to eliminate mutual interference of terminals with one another during high-speed signal transmission and enable faster and more stable transmission of signals.

### SUMMARY OF THE INVENTION

A primary object of the present invention is to provide a connector having individually isolated terminals, so that the terminals do not mutually interfere with one another during high-speed signal transmission, in order to enable faster and more stable transmission of signals.

Another object of the present invention is to provide a connector that has reduced noise or crosstalk produced during high-speed transmission, so that signals can be more stably transmitted.

A further object of the present invention is to provide a connector that eliminates static electricity possibly produced around terminals and therefore prevents the signal transmission from being interfered by static electricity.

To achieve the above and other objects, the connector of the present invention mainly includes a plastic body having a steel case put over a front end thereof, an insertion plate connected to a rear end of the plastic body, an intermediate cable including two rows of conductors separately set onto upper rear and lower rear sides of the insertion plate, and two hold-down plates separately covered onto upper and lower sides of the insertion plate to hold the conductors of the intermediate cable in place and then integrally connected to the insertion plate by way of high-frequency heat sealing. The plastic body, the insertion plate, and the hold-down plates are provided at predetermined positions with slots for receiving metal isolation plates therein, so that terminals on the plastic body are individually surrounded by the isolation plates to eliminate mutual interference and therefore enable stable transmission of signals at high speed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional connector;

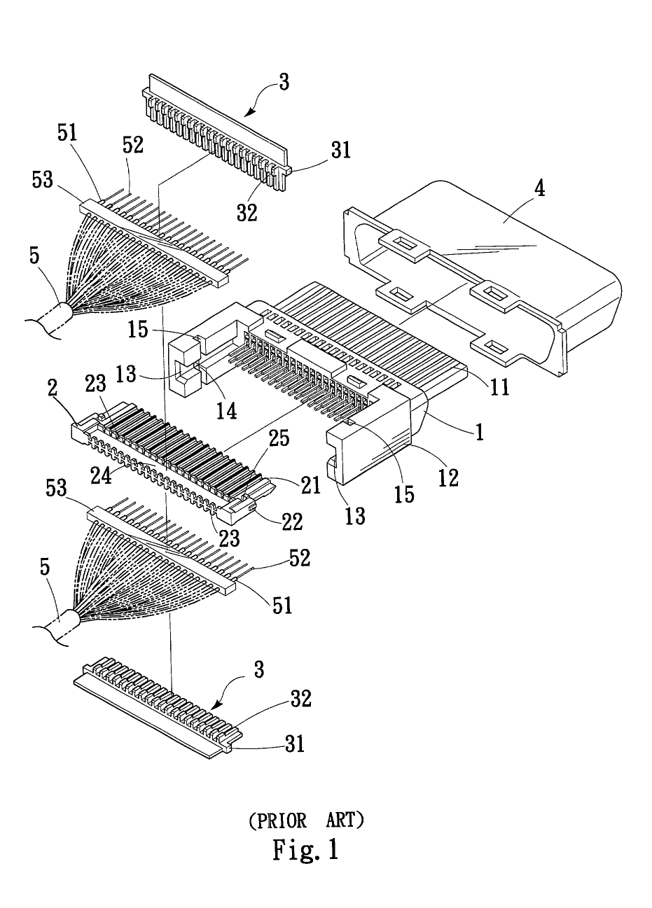

FIG. 2 is a partially assembled perspective view of the connector of FIG. 1 before two hold-down plates are covered onto the connector;

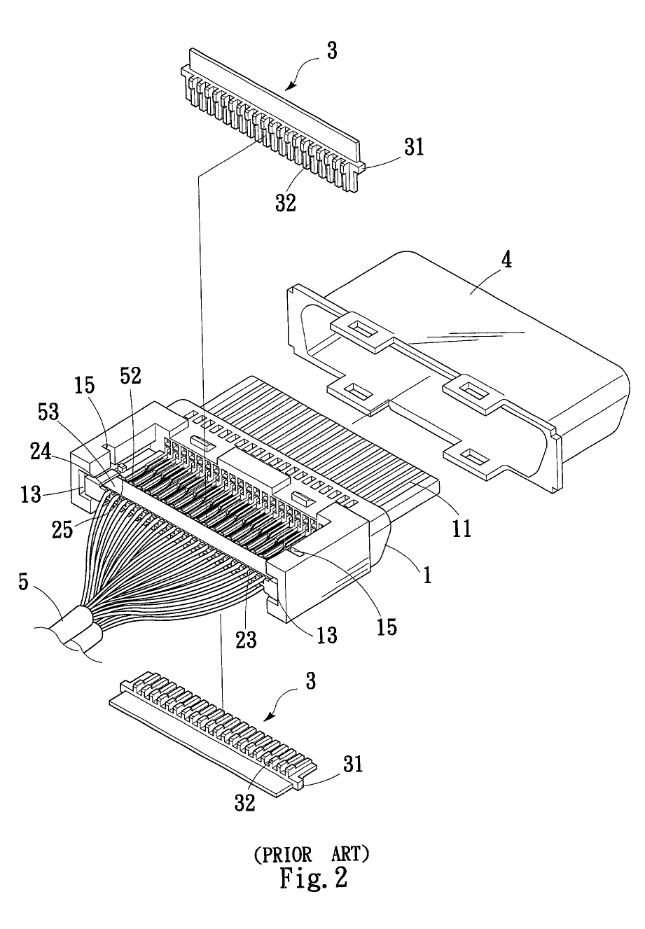

FIG. 3 is a fully assembled perspective view of the connector of FIG. 1;

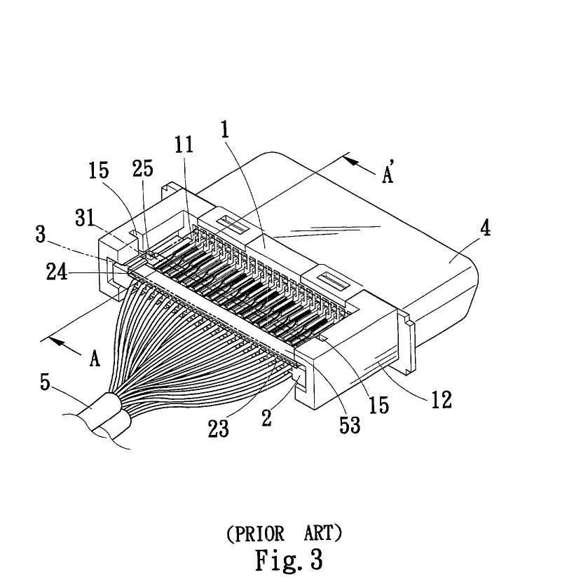

FIG. 4 is a sectional view taken along line A-A′ of FIG. 3;

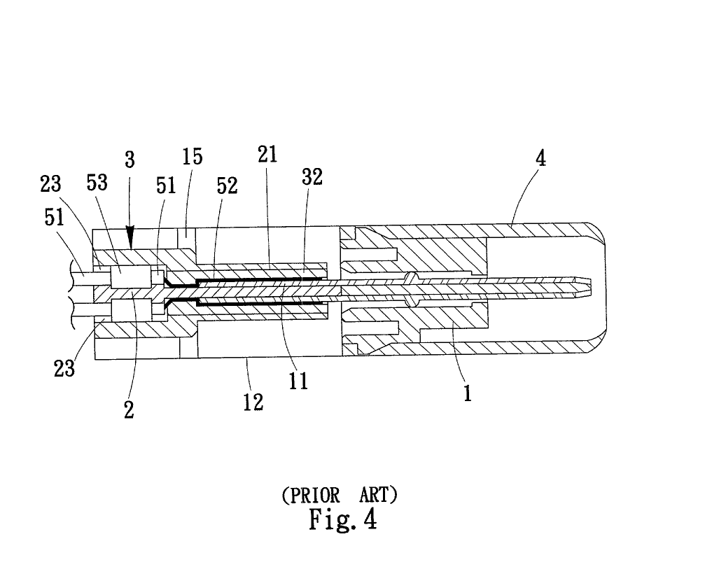

FIG. 5 is an exploded perspective view of a connector according to the present invention;

FIG. 6 is an assembled perspective view of the connector of FIG. 5;

FIG. 7 shows the first step of assembling the connector of the present invention by inserting terminals into terminal slots provided on a plastic body of the connector;

FIG. 8 shows the second step of assembling the connector of the present invention by inserting isolation plates into isolation slots provided on the plastic body of the connector;

FIG. 9 shows the third step of assembling the connector of the present invention by connecting an insertion plate to the plastic body of the connector;

FIG. 10 shows the fourth step of assembling the connector of the present invention by connecting an intermediate cable to the plastic body of the connector;

FIG. 11 shows the fifth step of assembling the connector of the present invention by covering two hold-down plates onto upper and lower sides of the plastic body of the connector to complete the assembling;

FIG. 12 is a sectional view taken along line A-A of FIG. 6; and

FIG. 13 is a sectional view taken along line B-B of FIG. 6.

### DETAILED DESCRIPTION OF THE PREFERRED EMBODIMENTS

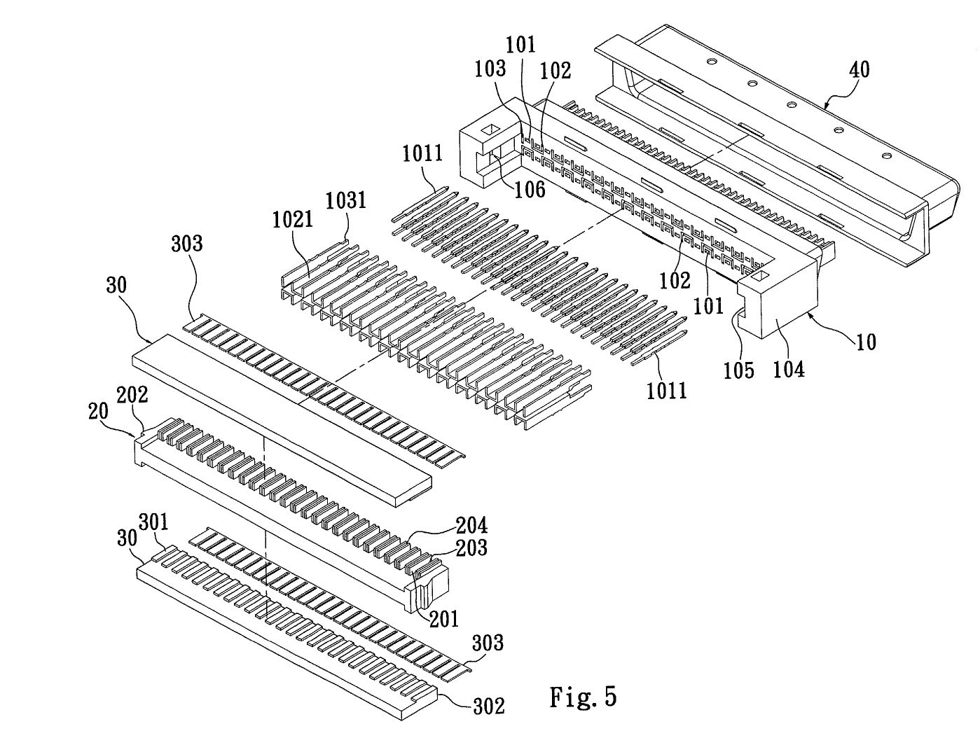

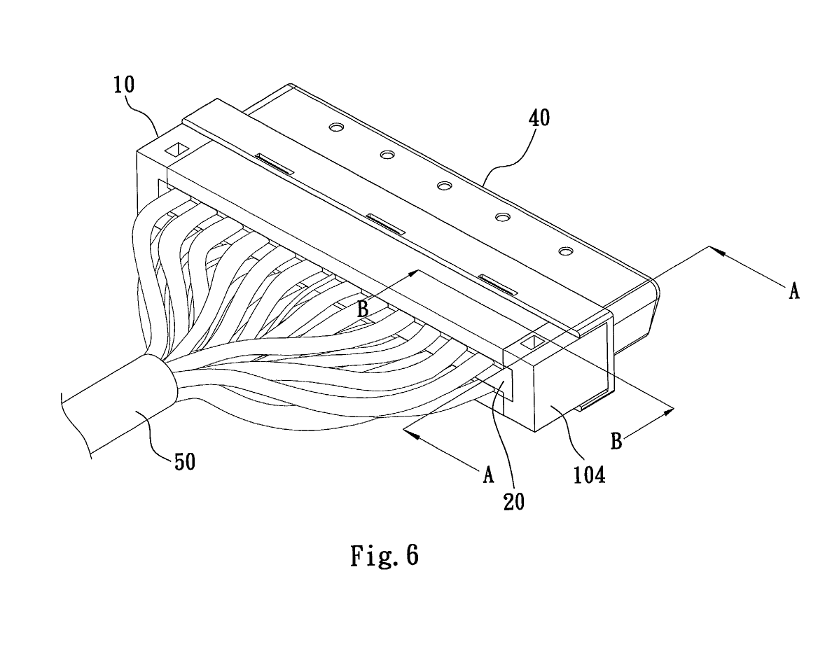

Please refer to FIGS. 5 and 6 that are exploded and assembled perspective views, respectively, of a connector according to the present invention. As shown, the connector includes a plastic body 10, an insertion plate 20, two hold-down plates 30, a steel case 40, and an intermediate cable 50. The steel case 40 is connected to and covers a front side of the plastic body 10, and the insertion plate 20 is assembled to a rear side of the plastic body 10.

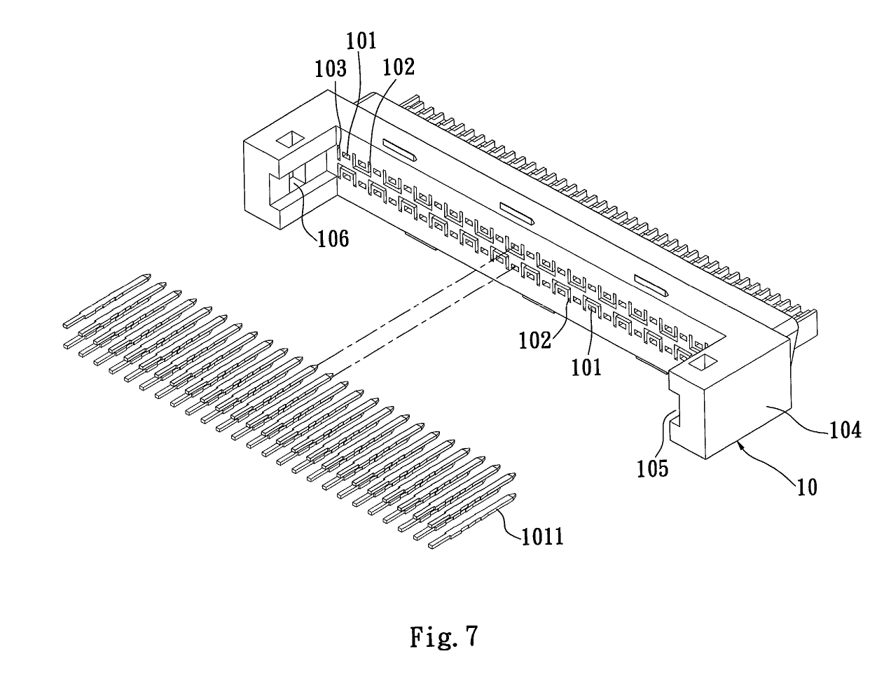

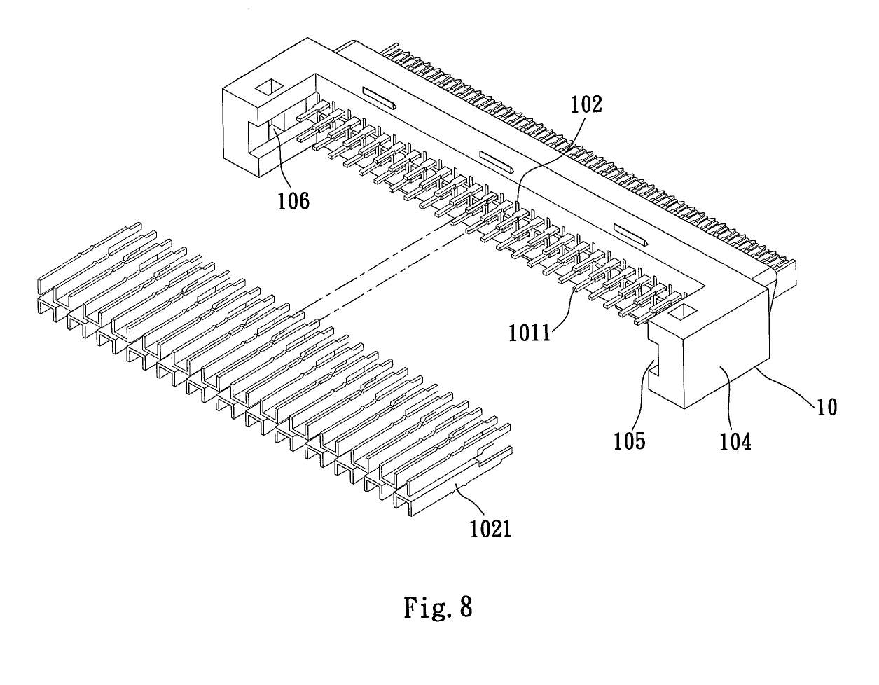

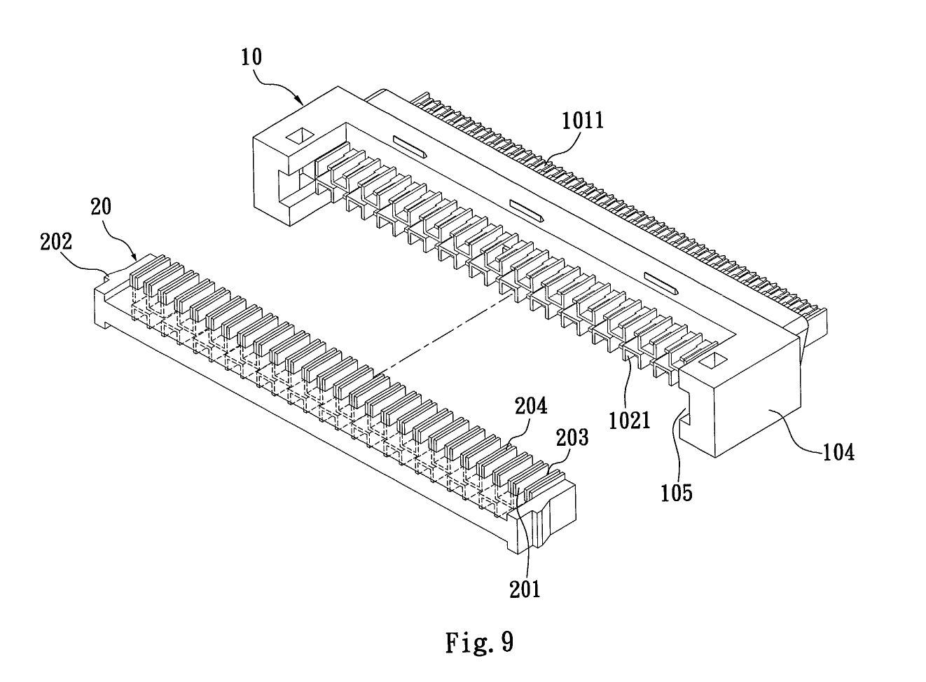

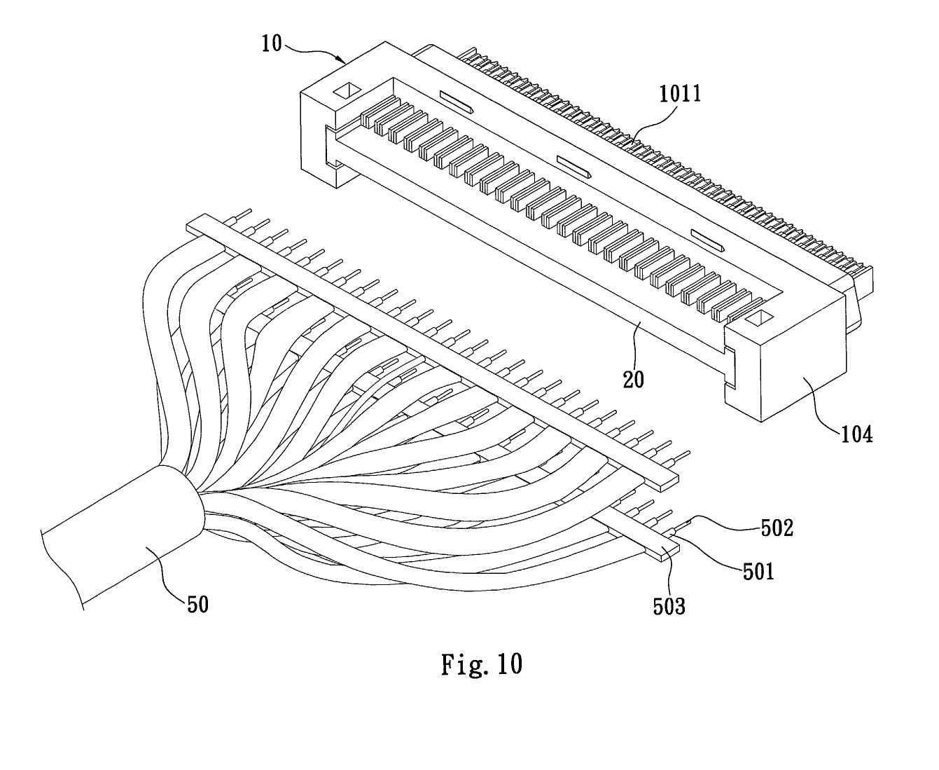

The plastic body 10 is provided at the rear side with upper and lower rows of correspondingly arranged terminal slots 101, into each of which a terminal 1011 is inserted, as shown in FIGS. 7 and 8. Every other terminal slots 101 in the same row has a substantially U-shaped isolation slot 102 provided therearound, and the U-shaped isolation slots 102 at the upper and the lower row are staggered. Each of the isolation slots 102 receives a front part of an isolation plate 1021 therein, as shown in FIGS. 8 and 9. Each of the isolation plates 1021 has an open side that faces outward corresponding to upper or lower side of the plastic body 10 to facilitate subsequent connection of the intermediate cables 50 to the terminals 1011. A straight vertical isolation slot 1031 is provided at outer side of two outmost terminal slots 101 that do not have the U-shaped isolation slots 102 provided therearound, so that an isolation plate 1031 having an I-shaped cross section can be inserted thereinto. The plastic body 10 includes two rearward extended lateral walls 104, inner surfaces of which are provided with horizontally extended guide slots 105. And, two retaining holes 106 are separately formed in the guide slots 105 at predetermined positions for holding the insertion plate 20 to the rear side of the plastic body 10, as shown in FIGS. 9 and 10.

The insertion plate 20 is provided at two lateral ends with two retaining projections 202 for engaging with the retaining holes 106 in the guide slots 105 of the plastic body 10, and at upper and lower surfaces with a plurality of spacing ribs 201. Any two adjacent spacing ribs 201 define a recess 203 between them for receiving a rear end of one corresponding terminal 1011, a front end of which has been inserted into the terminal slot 101 on the plastic body 10. Please refer to FIG. 9. Each spacing rib 201 is provided with a middle slot that vertically extends into the insertion plate 20, and the insertion plate 20 is provided below every other recess 203 with a horizontally extended slot to communicate with two adjacent middle slots at two sides of the recess 203, so that a substantially U-shaped isolation slot 204 is formed below every other recess 203 for receiving one isolation plate 1021 or 1031 therein.

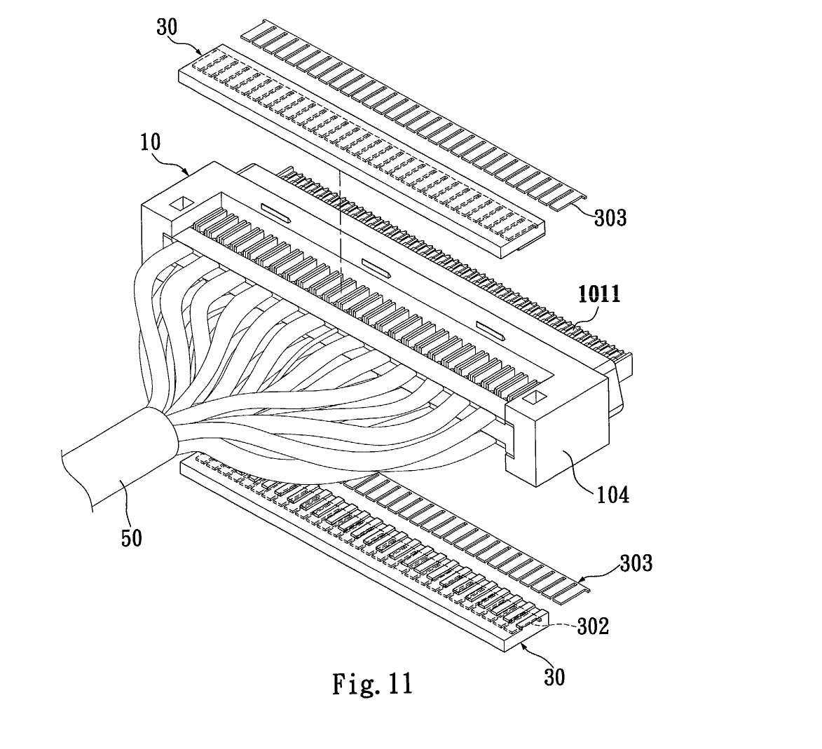

Please refer to FIG. 11. Each of the hold-down plates 30 is provided at front part of one side facing toward the upper or the lower surface of the insertion plate 20 with a plurality of raised hold-down ribs 301 corresponding to the isolation ribs 201 of the insertion plate 20, so that the hold-down plates 30 are covered onto upper and lower sides of the insertion plate 20 with the hold-down ribs 301 abutting on tops of the isolation ribs 201. The hold-down plate 30 is also provided at a front side with a plurality of isolation slots 302, such that the isolation slots 302 are separately located between and below two adjacent hold-down ribs 301 for receiving a row of flat isolation plates 303 therein. After the intermediate cable 50 and the terminals 1011 are connected together, the hold-down ribs 301 of the hold-down plates 30 are integrally connected to the tops of the spacing ribs 201 of the insertion plate 20 by way of high-frequency heat sealing.

Please refer to FIG. 10. The intermediate cable 50 includes a plurality of conductors 501 that are previously arranged into two rows corresponding to the terminals 1011 in the upper and the lower row of terminal slots 101, and then held in place with two horizontally extended clamp plates 503. Front ends of the conductors 501 are projected from a front side of the clamp plates 503 to expose a fixed length of bare wires 502 for connecting to the terminals 1011 by way of soldering.

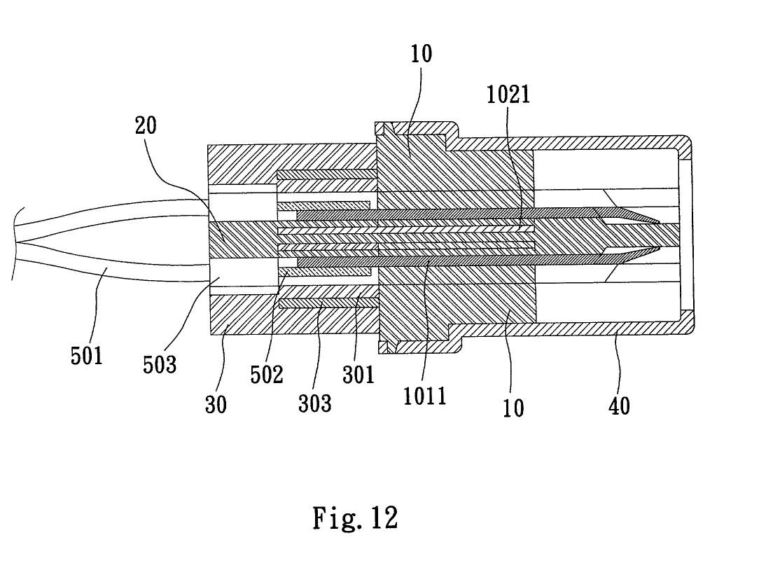

To assemble the connector of the present invention, first slide the insertion plate 20 into the plastic body 10 via the guide slots 105, and separately set the two clamp plates 503 of the intermediate cable 50 onto upper and lower sides of the insertion plate 20, so that every conductor 501 is located in a corresponding recess 203 between two adjacent spacing ribs 201, enabling the bare wire 502 of every conductor 501 to be soldered to the rear end of the corresponding terminal 1011. Thereafter, cover the two hold-down plates 30 onto upper and lower sides of the insertion plate 20 with the hold-down ribs 301 abutted against the spacing ribs 201. Finally, connect the hold-down ribs 301 and the spacing ribs 201 together by way of high-frequency heat sealing, and put the steel case 40 onto the front side of the plastic body 10 to complete the connector, as shown in FIG. 6. FIG. 12 is a sectional view taken along line A-A of FIG. 6 showing the assembled connector of the present invention.

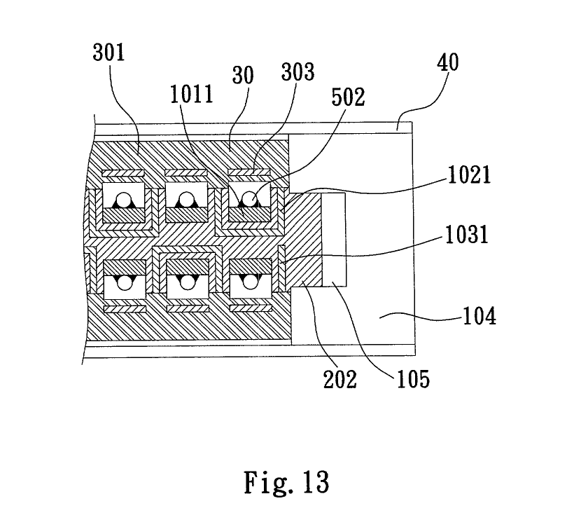

FIG. 13 is a fragmentary sectional view taken along line B-B of FIG. 6. As can be seen in FIG. 13, in the assembled connector, the isolation plates 1021, 1031, and 303 provide a plurality of isolation layers to surround the terminals 1011, so that every terminal 1011 is individually isolated. The individually isolated terminals 1011 do not mutually interfere with one another during transmission of signals at extremely high speed, so that the signals are transmitted faster and more stably.

The present invention has been described with a preferred embodiment thereof and it is understood that many changes and modifications in the described embodiment can be carried out without departing from the scope and the spirit of the invention as defined by the appended claims.

What is claimed is:

1. A connector, comprising a plastic body having a steel case put over a front side thereof, an insertion plate connected to a rear side of said plastic body, an intermediate cable including two rows of conductors separately set onto upper rear and lower rear sides of said insertion plate, and two hold-down plates separately covered onto upper and lower sides of said insertion plate to hold said conductors of said intermediate cable in place;
said plastic body including a plurality of terminal slots arranged in a predetermined manner for each receiving a terminal therein, and a plurality of first isolation slots provided at two lateral sides and a bottom side of each said terminal slot; each of said first isolation slots having a first isolation plate inserted therein, and each of said first isolation plates having an open side facing outward to facility subsequent connection of said intermediate cable to said terminals on said plastic body;
said insertion plate being provided at upper and lower surfaces with a plurality of spacing ribs, and a plurality of recesses defined between two said spacing ribs that are adjacent to each other to separately receive rear ends of said terminals therein, and said insertion plate also including a plurality of second isolation slots located below every other said recesses and in said spacing ribs at two sides of said recesses for engaging with rear ends of said first isolation plates, front ends of which have been inserted into said first isolation slots on said plastic body; and
each of said two hold-down plates being provided at a front side with a plurality of third isolation slots corresponding to said open side of said first isolation plates on said plastic body, and at front part of one side facing toward said insertion plate with a plurality of hold-down ribs corresponding to and adapted to integrally connect to tops of said spacing ribs on said insertion plate; and a row of connected second isolation plates being inserted into said third isolation slots provided on each of said hold-down plates, such that each said second isolation plate and a corresponding one of said first isolation plates together provide an isolation layer surrounding each said terminal located in said terminal slot;
whereby said terminals on said plastic body are individually isolated without mutually interfering with one another during transmission of signals at high speed, enabling signals to be transmitted faster and more stably.

2. The connector as claimed in claim 1, wherein said first isolation plates inserted onto said plastic body have a U-shaped cross section.

3. The connector as claimed in claim 1, wherein said plastic body is provided at outer sides of two said terminal slots that are separately located at outmost end of said upper and said lower row of terminal slots with two straight vertical isolation slots for each receiving a vertically extended flat isolation plate therein.

4. The connector as claimed in claim 1, wherein each of said second isolation plates inserted into said third isolation slot at the front side of each said hold-down plate is a horizontally extended flat plate.
